(19) United States
(12) Patent Application Publication
(10) Pub. No.: US 2025/0185719 A1
(43) Pub. Date: Jun. 12, 2025

(54) INHALATION DEVICE, CONTROL METHOD, AND STORAGE MEDIUM

(71) Applicant: Japan Tobacco Inc., Tokyo (JP)

(72) Inventor: Hiroshi TEZUKA, Tokyo (JP)

(73) Assignee: Japan Tobacco Inc., Tokyo (JP)

(21) Appl. No.: 19/053,705

(22) Filed: Feb. 14, 2025

Related U.S. Application Data
(63) Continuation of application No. PCT/JP2022/031136, filed on Aug. 17, 2022.

(51) Int. Cl. A24F 40/49; A24F 40/10; A24F 40/20; A24F 40/30; A24F 40/42; A24F 40/46; A24F 40/53; A24F 40/65; H05B 47/105

(52) U.S. Cl. CPC A24F 40/49; A24F 40/46; A24F 40/53; H05B 47/105; A24F 40/10; A24F 40/20; A24F 40/30; A24F 40/42; A24F 40/65

(57) ABSTRACT

An inhalation device that generates an aerosol from a base material including an aerosol source and delivers the generated aerosol to a user via a mouthpiece, includes: a main body portion configured to allow the base material and the mouthpiece to be mounted thereon; an input unit configured to receive an input from the user; and a control unit configured to control an operation of the inhalation device. When the base material and the mouthpiece are mounted on the main body portion, the control unit causes the inhalation device to perform an operation corresponding to the input received by the input unit.

### CROSS-REFERENCE TO RELATED APPLICATION

This is a continuation of International Application No. PCT/JP2022/031136 filed on Aug. 17, 2022, the entire content of which is incorporated herein by reference.

### TECHNICAL FIELD

The present disclosure relates to an inhalation device, a control method, and a storage medium storing a program.

### BACKGROUND ART

In the related art, for example, there is known an inhaler that generates an aerosol to which a flavor component is applied and allows a user to inhale the generated aerosol. Such an inhaler typically delivers, to the user, the aerosol generated by heating a base material containing an aerosol source with a heating unit (also referred to as a “heating element”) which is an electrical resistance heater or an induction heater. Further, such an inhaler also has a so-called “child resistance function” in order to prevent an occurrence of inconvenience caused by misuse by a child (for example, an infant and a young child).

For example, JP2020-506121A below discloses that, in order to restrict access to contents of a container, a combination of two or more different operations such as squeezing while rotating a cap is required, as the child resistance function.

Further, JP2019-505190A below discloses that a mouthpiece that moves relative to a main body portion between a first position and a second position to switch a device between a stopped state and an operating state is biased toward the first position by a spring or the like, and the device is maintained in the stopped state against a predetermined biasing force. It is disclosed that the predetermined biasing force can be selected to exceed a normal force of the infants (an expected hand force) in order to set the switching of the device in the operating state to be child-resistant.

### SUMMARY

However, a history of the technical development of the inhaler is still young. Therefore, there is a room for improvement in the child resistance function of the inhaler from a viewpoint of improving a performance.

Aspects of the present disclosure relates to providing an inhalation device, a control method, and a storage medium storing a program capable of further preventing an occurrence of inconvenience caused by misuse by a child.

According to an aspect of the present disclosure, there is provided an inhalation device that generates an aerosol from a base material including an aerosol source and delivers the generated aerosol to a user via a mouthpiece, the inhalation device including:
a main body portion configured to allow the base material and the mouthpiece to be mounted thereon;
an input unit configured to receive an input from the user; and
a control unit configured to control an operation of the inhalation device, in which
when the base material and the mouthpiece are mounted on the main body portion, the control unit causes the inhalation device to perform an operation corresponding to the input received by the input unit.

According to another aspect of the present disclosure, there is provided a control method to be performed by a computer for controlling an operation of an inhalation device that generates an aerosol from a base material including an aerosol source and delivers the generated aerosol to a user via a mouthpiece, the inhalation device including:
a main body portion configured to allow the base material and the mouthpiece to be mounted thereon, and
an input unit configured to receive an input from the user, the control method including:
when the base material and the mouthpiece are mounted on the main body portion, the computer causing the inhalation device to perform an operation corresponding to the input received by the input unit.

According to another aspect of the present disclosure, there is provided a non-transitory computer-readable storage medium storing a program to be executed by a computer for controlling an operation of an inhalation device that generates an aerosol from a base material including an aerosol source and delivers the generated aerosol to a user via a mouthpiece, the inhalation device including:
a main body portion configured to allow the base material and the mouthpiece to be mounted thereon, and
an input unit configured to receive an input from the user,
the program causing, when the base material and the mouthpiece are mounted on the main body portion, the computer to cause the inhalation device to perform an operation corresponding to the input received by the input unit.

According to aspects of the present disclosure, an inhalation device, a control method, and a storage medium storing a program capable of further preventing an occurrence of inconvenience caused by misuse by a child can be provided.

### BRIEF DESCRIPTION OF DRAWINGS

FIG. 1A is a schematic diagram schematically illustrating a first configuration example of an inhalation device;

FIG. 1B is a schematic diagram schematically illustrating a second configuration example of the inhalation device;

FIG. 2A is a front view of an inhalation device 100B in a state where a cap 20 is removed;

FIG. 2B is a front view of the inhalation device 100B in a state where the cap 20 is attached thereto;

FIG. 3A is a perspective view of the inhalation device 100B in a state where the cap 20 is removed therefrom;

FIG. 3B is a perspective view of the inhalation device 100B in a state where a mouthpiece 124B and a stick-type base material 150 are removed therefrom;

FIG. 4 is a diagram illustrating a first example of specific operations of the inhalation device 100B;

FIG. 5 is a diagram illustrating a second example of the specific operations of the inhalation device 100B;

FIG. 6 is a diagram illustrating a third example of the specific operations of the inhalation device 100B;

FIG. 7 is a diagram illustrating a fourth example of the specific operations of the inhalation device 100B;

FIG. 8 is a diagram illustrating another example of a light emitting unit 14;

FIG. 9 is a diagram illustrating a fifth example of the specific operations of the inhalation device 100B;

FIG. 10 is a diagram illustrating an example of a display unit 15;

FIG. 11 is a diagram illustrating a sixth example of the specific operations of the inhalation device 100B;

FIG. 12 is a flowchart illustrating an example of processing performed by a control unit 116B;

FIG. 13 is a diagram illustrating a modification of the inhalation device 100B illustrated in FIG. 1B; and

FIG. 14 is a diagram illustrating an example of conditions for generating aerosol by a heating unit 121 and conditions for communicating with an external device via a communication unit 115.

### DESCRIPTION OF EMBODIMENTS

Hereinafter, an inhalation device, a control method, and a storage medium storing a program according to an embodiment of the present disclosure will be described with reference to the drawings. Hereinafter, the same or similar elements are denoted by the same or similar reference numerals, and the description thereof may be appropriately omitted or simplified.

### <<1. Configuration Example of Inhalation Device>>

An inhalation device of the present embodiment is a device that generates a substance to be inhaled by a user. Hereinafter, the substance generated by the inhalation device will be described as an aerosol. Further, the substance generated by the inhalation device may be a gas.

### (1) First Configuration Example

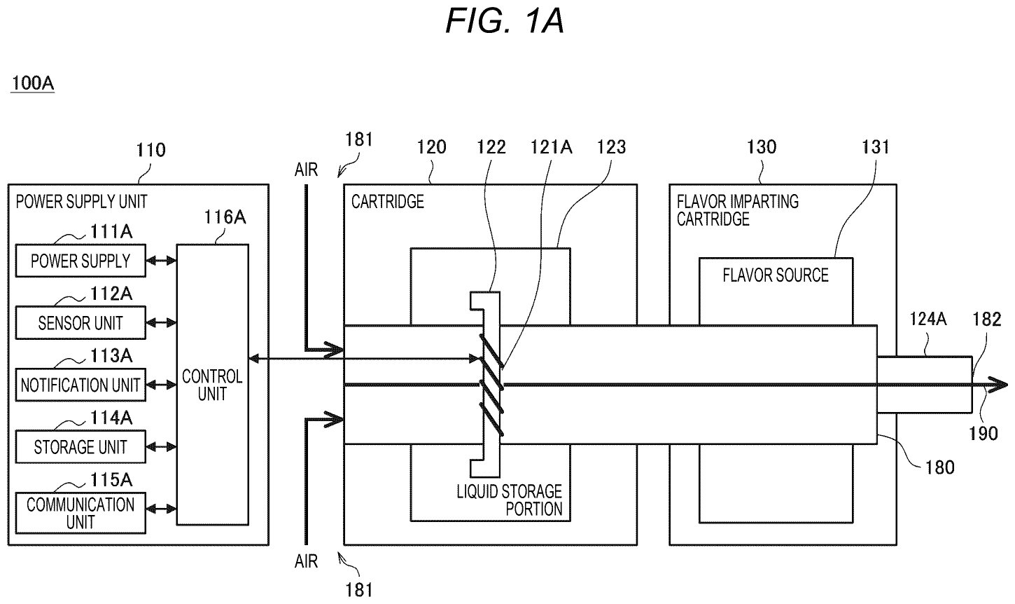

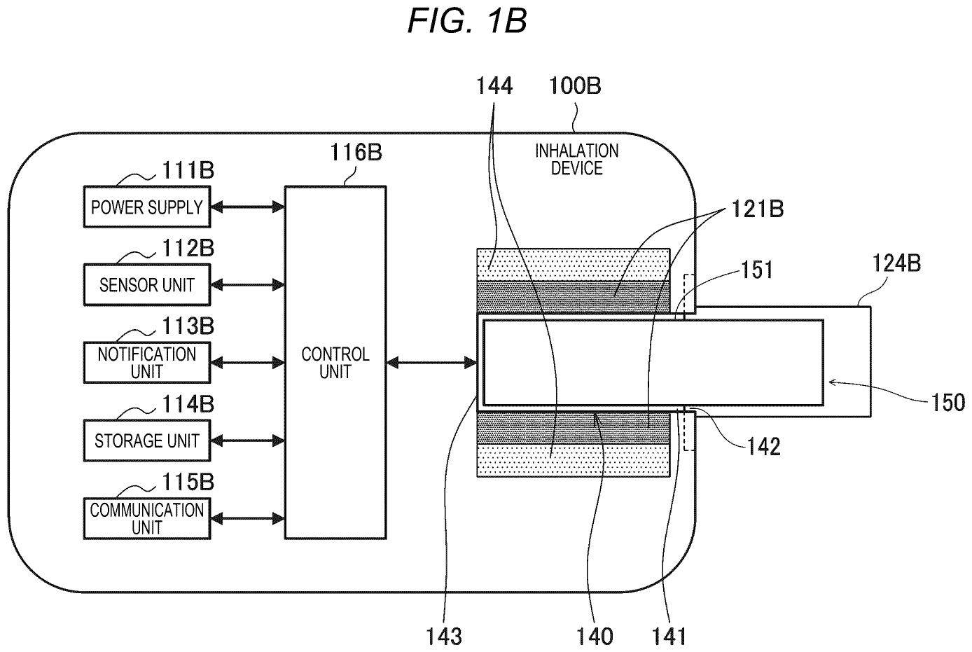

FIG. 1A is a schematic diagram schematically illustrating a first configuration example of the inhalation device. As illustrated in FIG. 1A, an inhalation device 100A according to the present configuration example includes a power supply unit 110, a cartridge 120, and a flavor imparting cartridge 130. The power supply unit 110 includes a power supply 111A, a sensor unit 112A, a notification unit 113A, a storage unit 114A, a communication unit 115A, and a control unit 116A. The cartridge 120 includes a heating unit 121A, a liquid guide portion 122, and a liquid storage portion 123. The flavor imparting cartridge 130 includes a flavor source 131 and a mouthpiece 124A. An air flow path 180 is formed in the cartridge 120 and the flavor imparting cartridge 130.

The power supply 111A stores electric power. The power supply 111A supply the electric power to each component of the inhalation device 100A under control of the control unit 116A. The power supply 111A may be implemented by, for example, a rechargeable battery such as a lithium-ion secondary battery.

The sensor unit 112A acquires various types of information related to the inhalation device 100A. As an example, the sensor unit 112A is implemented by a pressure sensor such as a condenser microphone, a flow rate sensor, a temperature sensor, or the like, and acquires a value associated with inhalation of the user. As another example, the sensor unit 112A is implemented by an input device that functions as an input unit for receiving an input of information (for example, various instructions) from the user, such as an operation button (for example, an operation button 13 to be described later) or a switch.

For example, the sensor unit 112A includes a pressure sensor (also referred to as a “puff sensor”) that detects a change in a pressure (that is, an internal pressure) inside the inhalation device 100A caused by the inhalation of the user. Further, the sensor unit 112A may include a flow rate sensor that detects a flow rate generated by the inhalation of the user, and a temperature sensor (also referred to as a “puff thermistor”) that detects a temperature of the heating unit 121A or around the heating unit 121A.

Further, in the present embodiment, the sensor unit 112A may include a base material detection sensor that detects an attachment state of the cartridge 120 and/or the flavor imparting cartridge 130. The base material detection sensor is implemented by, for example, a sensor that detects an electrostatic capacity, an inductance, or a pressure inside the inhalation device 100A that changes depending on whether the cartridge 120 or the like is attached, and detects, based on a detection result of the sensor, whether the cartridge 120 or the like is attached. As another example, the base material detection sensor may be implemented by an optical sensor such as a reflective photosensor, and may optically detect whether the cartridge 120 or the like is attached.

Further, in the present embodiment, the sensor unit 112A may include a mouthpiece detection sensor that detects an attachment state of the mouthpiece 124A. The mouthpiece detection sensor is implemented by, for example, a sensor that detects an electrostatic capacity, or a pressure inside the inhalation device 100A that changes depending on whether the mouthpiece 124A is attached, and detects, based on a detection result of the sensor, whether the mouthpiece 124A is attached. As another example, the mouthpiece detection sensor may detect whether the mouthpiece 124A is attached based on the presence or absence of electrical contact between an electrode provided in the inhalation device 100A (for example, a main body portion 10 to be described later) and an electrode provided in the mouthpiece 124A. As still another example, the mouthpiece detection sensor may be implemented by an optical sensor such as a reflective photosensor, and may optically detect whether the mouthpiece 124A is attached. Alternatively, information indicating whether the mouthpiece 124A is attached may be input by the user, and the sensor unit 112A may detect whether the mouthpiece 124A is attached based on the information received from the user.

Further, in the present embodiment, the sensor unit 112A may include a cap detection sensor that detects an attachment state of a cap 20 to be described later. The cap detection sensor is implemented by, for example, a sensor that detects the electrostatic capacity that changes depending on whether the cap 20 is attached to the inhalation device 100A (for example, the main body portion 10 to be described later), and detects, based on a detection result of the sensor, whether the cap 20 is attached. As another example, the cap detection sensor may detect whether the cap 20 is attached based on the presence or absence of electrical contact between an electrode provided in the inhalation device 100A (for example, the main body portion 10 to be described later) and an electrode provided in the cap 20. As still another example, the cap detection sensor may be implemented by an optical sensor such as a reflective photosensor, and may optically detect whether the cap 20 is attached. Alternatively, information indicating whether the cap 20 is attached may be input by the user, and the sensor unit 112A may detect whether the cap 20 is attached based on the information received from the user.

The notification unit 113A notifies the user of information. Examples of the notification unit 113A include a light emitting device (for example, a light emitting unit 14 to be described later) that emits light, a display device (for example, a display unit 15 to be described later) that displays an image, a sound output device that outputs sound, or a vibration device that vibrates.

The storage unit 114A stores various types of information for an operation of the inhalation device 100A. The storage unit 114A is implemented by, for example, a nonvolatile storage medium such as a flash memory.

The communication unit 115A is a communication interface capable of performing communication conforming to any wired or wireless communication standard. As such a communication standard, for example, a standard using Wi-Fi (registered trademark), Bluetooth (registered trademark), Bluetooth Low Energy (BLE (registered trademark)), Near Field Communication (NFC), or Low Power Wide Area (LPWA) may be adopted.

The control unit 116A functions as an arithmetic processing device and a control device, and controls overall operations in the inhalation device 100A according to various programs. The control unit 116A is implemented by, for example, an electronic circuit such as a central processing unit (CPU) or a microprocessor.

The liquid storage portion 123 stores an aerosol source. That is, the cartridge 120 including the liquid storage portion 123 for storing the aerosol source is an example of a base material including the aerosol source. The aerosol source is atomized to generate an aerosol. The aerosol source is, for example, a liquid such as water or a polyhydric alcohol such as glycerin and propylene glycol. The aerosol source may contain a flavor component derived from tobacco or non-tobacco. When the inhalation device 100A is a medical inhaler such as a nebulizer, the aerosol source may include a medical agent.

The liquid guide portion 122 guides the aerosol source, which is a liquid stored in the liquid storage portion 123, from the liquid storage portion 123 and holds the aerosol source. The liquid guide portion 122 is, for example, a wick formed by twisting a fibrous material such as glass fibers or a porous material such as porous ceramics. In that case, the aerosol source stored in the liquid storage portion 123 is induced by a capillary effect of the wick.

The heating unit 121A heats the aerosol source to atomize the aerosol source to generate the aerosol. In the example illustrated in FIG. 1A, the heating unit 121A is implemented by a coil and wound around the liquid guide portion 122. When the heating unit 121A generates heat, the aerosol source held by the liquid guide portion 122 is heated and atomized, and the aerosol is generated. The heating unit 121A generates heat when supplied with power from the power supply 111A. As an example, the heating unit 121A may be supplied with power when the sensor unit 112A detects that the user starts the inhalation and/or that predetermined information is input. Further, when the sensor unit 112A detects that the user finishes the inhalation and/or that predetermined information is input, the supply of power to the heating unit 121A may be stopped. An inhalation operation of the user with respect to the inhalation device 100A can be detected, for example, based on the fact that the pressure (internal pressure) inside the inhalation device 100A detected by the puff sensor exceeds a predetermined threshold.

The flavor source 131 is a component for imparting the flavor component to the aerosol. The flavor source 131 may contain the flavor component derived from tobacco or non-tobacco.

The air flow path 180 is a flow path of air inhaled by the user. The air flow path 180 has a tubular structure having an air inflow hole 181 which is an inlet of air into the air flow path 180 and an air outflow hole 182 which is an outlet of air from the air flow path 180 as both ends. In the middle of the air flow path 180, the liquid guide portion 122 is disposed on an upstream side (a side close to the air inflow hole 181), and the flavor source 131 is disposed on a downstream side (a side close to the air outflow hole 182). The air flowing in from the air inflow hole 181 in response to the inhalation of the user is mixed with the aerosol generated by the heating unit 121A, passes through the flavor source 131, and is transported to the air outflow hole 182 as indicated by an arrow 190. When a mixed fluid of the aerosol and the air passes through the flavor source 131, the flavor component contained in the flavor source 131 is imparted to the aerosol.

The mouthpiece 124A is a member that can be held by the user in his/her mouth during the inhalation. The air outflow hole 182 is disposed in the mouthpiece 124A. The user can take in the mixed fluid of the aerosol and the air into the oral cavity by holding the mouthpiece 124A in his/her mouth and inhaling the mouthpiece 124A. That is, the inhalation device 100A delivers the generated aerosol to the user via the mouthpiece 124A.

The configuration example of the inhalation device 100A has been described above. It is needless to say that the configuration of the inhalation device 100A is not limited to the above, and may adopt various configurations as exemplified below.

As an example, the inhalation device 100A may not include the flavor imparting cartridge 130. In this case, the mouthpiece 124A is provided on the cartridge 120.

As another example, the inhalation device 100A may further include a second heating unit that heats the flavor source 131. In this case, the second heating unit is formed in a film shape, for example, and is disposed to cover an outer periphery of the flavor imparting cartridge 130. Then, the second heating unit generates heat when being supplied with electric power from the power supply 111A, and heats the flavor imparting cartridge 130 from the outer periphery. By providing such a second heating unit, a temperature of the flavor source 131 can be increased and an amount of the flavor component applied to the aerosol can be increased, as compared with a case where the second heating unit is not provided. When such a second heating unit is provided, the second heating unit is controlled such that an actual temperature becomes a predetermined target temperature, for example, similarly to a heating unit 121B to be described later.

As another example, the inhalation device 100A may include a plurality of types of aerosol sources. A plurality of types of aerosols generated from the plurality of types of aerosol sources may be mixed in the air flow path 180 to cause a chemical reaction, thereby generating another type of aerosol.

A method for atomizing the aerosol source is not limited to heating by the heating unit 121A. For example, the method for atomizing the aerosol source may be vibratory atomization or induction heating.

### (2) Second Configuration Example

FIG. 1B is a schematic diagram schematically illustrating a second configuration example of the inhalation device. As illustrated in FIG. 1B, an inhalation device 100B according to the present configuration example includes a power supply 111B, a sensor unit 112B, a notification unit 113B, a storage unit 114B, a communication unit 115B, a control unit 116B, a heating unit 121B, an accommodating portion 140, and a heat insulating portion 144.

The power supply 111B, the sensor unit 112B, the notification unit 113B, the storage unit 114B, the communication unit 115B, and the control unit 116B are substantially the same as the corresponding components provided in the inhalation device 100A according to the first configuration example.

In the sensor unit 112B, the base material detection sensor is implemented by a sensor that detects an electrostatic capacity, an inductance, or a pressure inside the inhalation device 100B that changes depending on whether a stick-type base material 150 to be described later is attached to the inhalation device 100B (for example, the main body portion 10 to be described later), and detects, based on a detection result of the sensor, whether the stick-type base material 150 is attached. As another example, the base material detection sensor may optically detect whether the stick-type base material 150 is attached.

Further, in the sensor unit 112B, the mouthpiece detection sensor is implemented by a sensor that detects the electrostatic capacity, or the pressure inside the inhalation device 100B that changes depending on whether a mouthpiece 124B to be described later is attached to the inhalation device 100B (for example, the main body portion 10 to be described later), and detects, based on a detection result of the sensor, whether the mouthpiece 124B is attached. As another example, the mouthpiece detection sensor may detect whether the mouthpiece 124B is attached based on the presence or absence of electrical contact between an electrode provided in the inhalation device 100B (for example, the main body portion 10 to be described later) and an electrode provided in the mouthpiece 124B. As another example, the mouthpiece detection sensor may optically detect whether the mouthpiece 124B is attached. Alternatively, the sensor unit 112B may detect whether the mouthpiece 124B is attached based on information received from the user.

Further, in the sensor unit 112B, the cap detection sensor is implemented by a sensor that detects the electrostatic capacity that changes depending on whether the cap 20 is attached to the inhalation device 100B (for example, the main body portion 10 to be described later), and detects, based on a detection result of the sensor, whether the cap 20 is attached. As another example, the cap detection sensor may detect whether the cap 20 is attached based on the presence or absence of electrical contact between an electrode provided in the inhalation device 100B (for example, the main body portion 10 to be described later) and an electrode provided in the cap 20. As still another example, the cap detection sensor may optically detect whether the cap 20 is attached. Alternatively, the sensor unit 112B may detect whether the cap 20 is attached based on information received from the user.

The accommodating portion 140 has an internal space 141, and holds the stick-type base material 150 while accommodating a part of the stick-type base material 150 in the internal space 141. The accommodating portion 140 has an opening 142 through which the internal space 141 communicates with the outside, and holds the stick-type base material 150 inserted into the internal space 141 from the opening 142. For example, the accommodating portion 140 is a cylindrical body having the opening 142 and a bottom portion 143 as a bottom surface, and defines the columnar internal space 141. An air flow path for supplying air to the internal space 141 is connected to the accommodating portion 140. An air inflow hole, which is an inlet of air to the air flow path, is disposed, for example, in a side surface of the inhalation device 100. An air outflow hole, which is an outlet of air from the air flow path to the internal space 141, is disposed, for example, in the bottom portion 143.

The stick-type base material 150 includes a base material portion 151. The base material portion 151 includes the aerosol source. That is, the stick-type base material 150 is another example of the base material including the aerosol source. The aerosol source contains the flavor component derived from tobacco or non-tobacco. When the inhalation device 100B is a medical inhaler such as a nebulizer, the aerosol source may include a medical agent. For example, the aerosol source may be a liquid such as water and polyhydric alcohols such as glycerin and propylene glycol, including the flavor component derived from tobacco or non-tobacco, or may be a solid including the flavor component derived from tobacco or non-tobacco.

In a state where the stick-type base material 150 is held by the accommodating portion 140, at least a part of a base material portion 151 is accommodated in the internal space 141. The mouthpiece 124B of the inhalation device 100B is attached to cover the stick-type base material 150 accommodated in the accommodating portion 140. When the user holds the mouthpiece 124B in his/her mouth and inhales, air flows into the internal space 141 through the air flow path that is not illustrated, and reaches the oral cavity of the user together with the aerosol generated from the base material portion 151. That is, the inhalation device 100B delivers the generated aerosol to the user via the mouthpiece 124B.

In the example illustrated in FIG. 1B, the heating unit 121B is formed in a film shape, and is disposed to cover an outer periphery of the accommodating portion 140. Then, when the heating unit 121B generates heat, the base material portion 151 of the stick-type base material 150 is heated from the outer periphery thereof, and the aerosol is generated.

The heat insulating portion 144 prevents heat transfer from the heating unit 121B to other components. For example, the heat insulating portion 144 is made of a vacuum heat insulating material or an aerogel heat insulating material.

The configuration example of the inhalation device 100B has been described above. It is needless to say that the configuration of the inhalation device 100B is not limited to the above, and may adopt various configurations as exemplified below.

As an example, the heating unit 121B may be formed in a blade shape and disposed to protrude from the bottom portion 143 of the accommodating portion 140 into the internal space 141. In this case, the blade-shaped heating unit 121B is inserted into the base material portion 151 of the stick-type base material 150, and heats the base material portion 151 of the stick-type base material 150 from the inside. As another example, the heating unit 121B may be disposed to cover the bottom portion 143 of the accommodating portion 140. Further, the heating unit 121B may be configured as a combination of two or more of a first heating unit covering the outer periphery of the accommodating portion 140, a blade-shaped second heating unit, and a third heating unit covering the bottom portion 143 of the accommodating portion 140.

As another example, the accommodating portion 140 may include an opening and closing mechanism such as a hinge that opens and closes a part of an outer shell forming the internal space 141. The accommodating portion 140 may open and close the outer shell to sandwich and accommodate the stick-type base material 150 inserted into the internal space 141. In this case, the heating unit 121B may be provided at a sandwiching place in the accommodating portion 140, and may heat the stick-type base material 150 while pressing the stick-type base material 150.

The method for atomizing the aerosol source is not limited to heating by the heating unit 121B. For example, the method for atomizing the aerosol source may be induction heating. In this case, the inhalation device 100B at least includes an electromagnetic induction source such as a coil for generating a magnetic field, instead of the heating unit 121B. A susceptor that generates heat due to the induction heating may be provided in the inhalation device 100B or may be provided in the stick-type base material 150.

The inhalation device 100B may further include the heating unit 121A, the liquid guide portion 122, the liquid storage portion 123, and the air flow path 180 according to the first configuration example, and the air flow path 180 may supply air to the internal space 141. In this case, the mixed fluid of the aerosol and the air generated by the heating unit 121A flows into the internal space 141, is further mixed with the aerosol generated by the heating unit 121B, and reaches the oral cavity of the user.

### <<2. External Configuration Example of Inhalation Device>>

Next, an external configuration example of an inhalation device 100 (100A, 100B) of the present embodiment will be described. Here, the inhalation device 100 is described as being the inhalation device 100B illustrated in FIG. 1B, but the present disclosure is not limited thereto, and the same can be applied to a case where the inhalation device 100 is the inhalation device 100A illustrated in FIG. 1A.

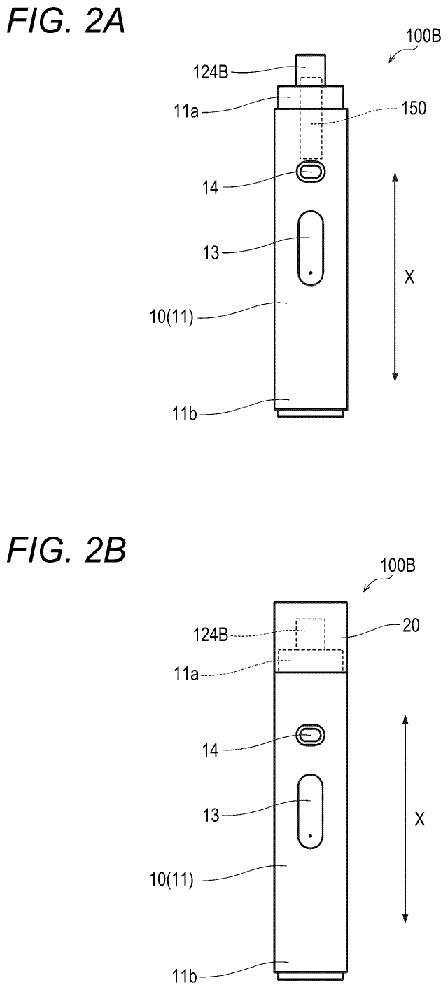

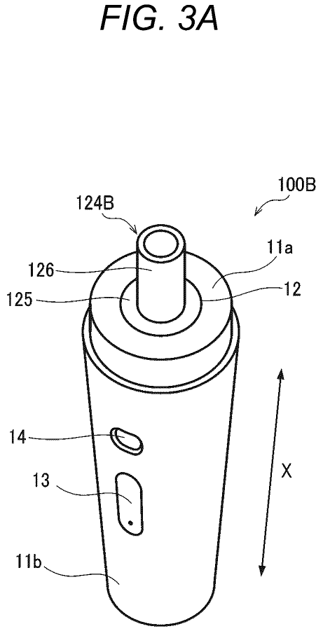

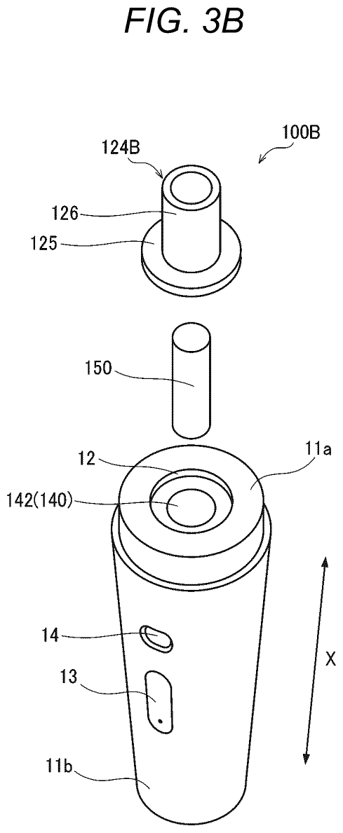

FIG. 2A is a front view of the inhalation device 100B in a state where the cap 20 is removed therefrom. FIG. 2B is a front view of the inhalation device 100B in a state where the cap 20 is attached thereto. FIG. 3A is a perspective view of the inhalation device 100B in a state where the cap 20 is removed therefrom. FIG. 3B is a perspective view of the inhalation device 100B in a state where the mouthpiece 124B and the stick-type base material 150 are removed therefrom.

As illustrated in FIGS. 2A, 2B, 3A, and 3B, the inhalation device 100B includes the main body portion 10 having a rod shape extending along a predetermined direction (hereinafter also referred to as a “longitudinal direction X”). The main body portion 10 is configured to accommodate, inside a main body housing 11 having a cylindrical shape, components such as the power supply 111B, the sensor unit 112B, the notification unit 113B, the storage unit 114B, the communication unit 115B, the control unit 116B, and the heating unit 121B of the inhalation device 100B illustrated in FIG. 1B. The main body portion 10 is not limited to the rod shape, and may have, for example, a rectangular parallelepiped shape, an egg-shaped shape, or an elliptical shape.

The mouthpiece 124B is attached to a top portion 11a positioned on one end side in the longitudinal direction X of the main body portion 10. As illustrated in FIGS. 3A and 3B, the mouthpiece 124B includes a base portion 125 that can be fitted to a mouthpiece holder 12 provided on the top portion 11a, and a cylindrical inhalation port portion 126 that protrudes from the base portion 125.

The mouthpiece 124B is attached to the main body portion 10 by the base portion 125 being fitted to the mouthpiece holder 12 of the main body portion 10 in a state where the inhalation port portion 126 faces a side opposite to the main body portion 10. Further, when the mouthpiece 124B attached to the main body portion 10 is pulled by a force equal to or greater than a certain force in a direction opposite to the main body portion 10, the base portion 125 is separated from the mouthpiece holder 12. Accordingly, the mouthpiece 124B can be removed from the main body portion 10. In this manner, the main body portion 10 is configured such that the mouthpiece 124B is detachable (that is, mounted).

The top portion 11a is further provided with an opening 142. The opening 142 is provided to overlap the mouthpiece holder 12 when viewed from the longitudinal direction X. When the mouthpiece 124B is attached to the main body portion 10, the opening 142 is covered by the mouthpiece 124B and is difficult for the user to see. Meanwhile, by removing the mouthpiece 124B from the main body portion 10, the user can easily insert the stick-type base material 150 into the accommodating portion 140 in the main body portion 10 from the opening 142 or easily remove the stick-type base material 150 accommodated in the accommodating portion 140.

As illustrated in FIG. 2B, the cap 20 that covers the mouthpiece 124B attached to the main body portion 10 can be further mounted to the top portion 11a. When the user does not perform inhalation of the aerosol (that is, smoking) using the inhalation device 100B, by mounting the cap 20 on the main body portion 10, the mouthpiece 124B can be prevented from being exposed to the outside, and the mouthpiece 124B can be kept hygienically.

A charging terminal (not illustrated) electrically connectable to an external power supply, for example, is provided in a bottom portion 11b positioned on the other end side in the longitudinal direction X of the main body portion 10. As the charging terminal, a USB terminal (for example, a USB Type-C terminal) may be adopted. The user can charge the power supply 111B using electric power of the external power supply by connecting the inhalation device 100B to the external power supply via the charging terminal. The charging terminal may be used at the time of connecting the inhalation device 100B and an external device (for example, another device such as a smartphone of the user) of the inhalation device 100B in a wired manner.

The operation button 13 and the light emitting unit 14 are provided on a side surface of the main body portion 10 at a position between the top portion 11a and the bottom portion 11b. The operation button 13 is an example of an operation unit that can be pressed down by the user, and may be implemented by a push-button-type operation button that the user can physically press down. As another example, the operation button 13 may be implemented by an electrostatic-capacity-type or resistance-film-type touch sensor.

The light emitting unit 14 is an example of a light emitting unit that emits light, and for example, includes one or more light emitting elements. As the light emitting element of the light emitting unit 14, for example, a light emitting diode (LED) may be adopted. As an example, the light emitting unit 14 includes a plurality of LEDs having different emission colors, and is configured to emit light in a plurality of emission colors including blue, yellow, and red.

The light emitting unit 14 emits light in a predetermined light emitting mode under control of the control unit 116B, thus notifying the user of predetermined information. Here, the light emitting mode can be, for example, a light emission color, but is not limited thereto, and may be, for example, an intensity of lighting (in other words, brightness) or a lighting pattern (for example, blinking at a predetermined time interval). Examples of the notification performed by the light emitting unit 14 include a first notification, a second notification, and a third notification to be described later.

### <<3. Operation Example of Inhalation Device>>

Next, an operation example of the inhalation device 100 of the present embodiment will be described. A control unit 116 (116A, 116B) may operate the inhalation device 100 based on an input from the user. As an example, in response to a heating start instruction from the user, the control unit 116 causes a heating unit 121 (121A and 121B) to generate the aerosol.

The heating start instruction is, for example, a predetermined operation (hereinafter, also referred to as a “heating start operation”) for instructing the inhalation device 100 to start heating. In the present embodiment, a predetermined operation using the operation button 13 is the heating start operation (that is, the heating start instruction).

For example, in a case where the inhalation device 100 is the inhalation device 100A illustrated in FIG. 1A, when the heating start operation is detected, the control unit 116A generates the aerosol for a certain period of time (for example, 5 [min]) subsequent to the detection, in response to an inhalation operation on the inhalation device 100A. More specifically, at this time, each time an inhalation operation on the inhalation device 100A is detected based on the detection result of the puff sensor, the control unit 116A supplies a predetermined amount of electric power to the heating unit 121A to generate the aerosol. The electric power supplied to the heating unit 121A is determined in advance by a manufacturer of the inhalation device 100A in order to generate an appropriate amount of aerosol including an appropriate amount of flavor components, for example. Accordingly, it is possible to provide a high-quality smoking experience to the user.

Further, in a case where the inhalation device 100 is the inhalation device 100B illustrated in FIG. 1B, when the heating start operation is detected, the control unit 116B starts temperature control on the heating unit 121B based on a heating profile prepared in advance. Here, the heating profile is information that defines a time-series transition of a target temperature that is a target value of the temperature of the heating unit 121B, and is stored in advance in the storage unit 114B, for example.

When the temperature control on the heating unit 121B based on the heating profile (hereinafter also referred to as “heating control based on the heating profile”) is described in detail, the control unit 116B controls the temperature of the heating unit 121B based on a deviation between the target temperature corresponding to an elapsed time from the start of the heating control based on the heating profile and an actual temperature of the heating unit 121B (hereinafter also referred to as an “actual temperature”). More specifically, at this time, the control unit 116B controls the temperature of the heating unit 121B such that a time-series transition of the actual temperature of the heating unit 121B is the same as the time-series transition of the target temperature defined in the heating profile.

The temperature control on the heating unit 121B can be achieved by, for example, known feedback control. For example, the control unit 116B supplies the electric power from the power supply 111B to the heating unit 121B in a form of pulses subjected to pulse width modulation (PWM) or pulse frequency modulation (PFM). In this case, the control unit 116B can perform the temperature control on the heating unit 121B by adjusting a duty ratio of the power pulses.

In the feedback control, the control unit 116B may control the electric power supplied to the heating unit 121B, for example, the duty ratio based on a difference between the actual temperature and the target temperature and the like. The feedback control may be, for example, proportional-integral-differential controller (PID) control. Alternatively, the control unit 116B may perform simple ON-OFF control. For example, the control unit 116B may perform the heating using the heating unit 121B before the actual temperature reaches the target temperature, stop the heating using the heating unit 121B when the actual temperature reaches the target temperature, and perform the heating using the heating unit 121B again when the actual temperature becomes lower than the target temperature.

The temperature of the heating unit 121B can be acquired (in other words, quantified), for example, by measuring or estimating an electrical resistance value of a heating resistor constituting the heating unit 121B. This is because the electrical resistance value of the heating resistor changes according to the temperature. The electrical resistance value of the heating resistor can be estimated (that is, acquired), for example, by measuring a voltage drop amount in the heating resistor. The voltage drop amount in the heating resistor can be measured (that is, acquired) by a voltage sensor that measures a potential difference applied to the heating resistor.

As another example, the temperature of the heating unit 121B may be measured by a temperature sensor (the puff thermistor) provided near the heating unit 121B.

The heating profile is typically designed to optimize a flavor experienced by the user when the user inhales the aerosol generated from the stick-type base material 150. Thus, by controlling the temperature of the heating unit 121B based on the heating profile, it is possible to optimize the flavor experienced by the user, and provide a high-quality smoking experience to the user.

In an inhaler that generates a substance to be inhaled by a user, such as the inhalation device 100, in order to prevent an occurrence of inconvenience caused by misuse by a child of a mischievous age (for example, an infant and a young child who are three years old or younger. Hereinafter, also simply referred to as a “child”), a so-called “child resistance function (hereinafter also referred to as an “CR function”)” may be implemented. For example, it is conceivable that, as the CR function in such an inhaler, a predetermined operation such as generating the substance to be inhaled is performed only when a predetermined operation is performed on the operation unit (for example, an operation button) provided in the inhaler.

However, a history of the technical development of the inhaler is still young, and there is a room for improvement in the CR function of the inhaler. It is desirable for the CR function in such an inhaler to be capable of preventing the occurrence of inconvenience caused by the misuse by the child, without compromising convenience for a legitimate user such as an adult (for example, an adult of 20 years old or elder) as much as possible.

Therefore, in the present embodiment, when the base material including the aerosol source such as the cartridge 120, the flavor imparting cartridge 130, or the stick-type base material 150, and a mouthpiece 124 (124A, 124B) for delivering the generated aerosol to the user are mounted on the main body portion 10 of the inhalation device 100, the control unit 116 causes the inhalation device 100 to perform an operation corresponding to an input received from the user. Accordingly, it is possible to prevent the inhalation device 100 from operating in response to an input (for example, pressing down the operation button 13) from the user such as a child who does not grasp a correct use method of the inhalation device 100 such as mounting the base material including the aerosol source and the mouthpiece 124 to the main body portion 10.

Meanwhile, according to the present embodiment, the inhalation device 100 can be operated in response to an input from a legitimate user, such as an adult, who grasps the correct use method of the inhalation device 100 such as mounting the base material including the aerosol source and the mouthpiece 124 to the main body portion 10. Accordingly, the convenience of the inhalation device 100 for the user who grasps the correct use method of the inhalation device 100 can be prevented from being decreased.

As described above, according to the present embodiment, the occurrence of inconvenience caused by the misuse by the child can be prevented, without compromising the convenience for the adult (that is, the legitimate user) as much as possible. Accordingly, a performance of the CR function in the inhalation device 100 is improved, and marketability of the inhalation device 100 is improved.

Hereinafter, the operation example of the inhalation device 100 will be described more specifically. As an example, the heating start operation is hereinafter a long press on the operation button 13. More specifically, the heating start operation is press-down of the operation button 13 that continues Tx [s] (for example, 3 [s]) or longer. Accordingly, it is possible to prevent the heating start operation from being unintentionally performed by the user such as a child who does not grasp the correct use method of the inhalation device 100, as compared with a case where the heating start operation is a simple “press-down of the operation button 13 (press-down for any duration)”.

Instead of the long press of the operation button 13, the heating start operation may be a plurality of times (for example, three times within a certain period of time) of press-down of the operation button 13. As described above, when the heating start operation is a plurality of times of press-down of the operation button 13, it is also possible to prevent the heating start operation from being unintentionally performed by the user who does not grasp the correct use method of the inhalation device 100.

As an example, hereinafter, the inhalation device 100 is described as being the inhalation device 100B illustrated in FIG. 1B, but the present disclosure is not limited thereto, and the same can be applied to the case where the inhalation device 100 is the inhalation device 100A illustrated in FIG. 1A. In this case, in the following description, the “inhalation device 100B” may be read as the “inhalation device 100A”, the “stick-type base material 150” may be read as the “cartridge 120 (and/or the flavor imparting cartridge 130)”, the “mouthpiece 124B” may be read as the “mouthpiece 124A”, the “sensor unit 112B” may be read as the “sensor unit 112A”, the “notification unit 113B” may be read as the “notification unit 113A”, and the “heating unit 121B” may be read as the “heating unit 121A”.

### (1) First Example of Specific Operations of Inhalation Device 100B

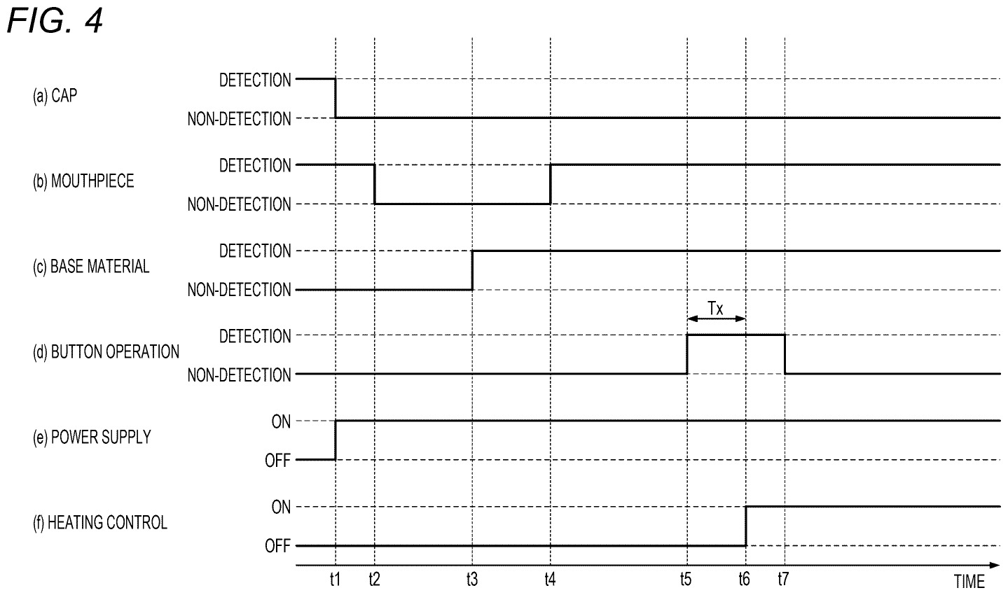

FIG. 4 is a diagram illustrating a first example of specific operations of the inhalation device 100B. A horizontal axis in FIG. 4 represents a time. (a) of FIG. 4 represents a detection state (detection/non-detection) of the cap 20 by the sensor unit 112B at each time indicated in the horizontal axis of FIG. 4. (b) of FIG. 4 shows a detection state (detection/non-detection) of the mouthpiece 124B by the sensor unit 112B at the each time indicated in the horizontal axis of FIG. 4. (c) of FIG. 4 represents a detection state (detection/non-detection) of the stick-type base material 150 by the sensor unit 112B at the each time indicated in the horizontal axis of FIG. 4. (d) of FIG. 4 represents a detection state (detection/non-detection) of an operation on the operation button 13 (that is, the press-down of the operation button 13) at the each time indicated in the horizontal axis of FIG. 4. (e) of FIG. 4 shows ON/OFF of the power supply of the inhalation device 100B at the each time indicated in the horizontal axis of FIG. 4. (f) of FIG. 4 represents ON (heating control)/OFF (no heating control) of the heating control on the heating unit 121B at the each time indicated in the horizontal axis of FIG. 4.

In the example illustrated in FIG. 4, it is assumed that the user removes the cap 20 from the main body portion 10 at a time t1 at which the power supply of the inhalation device 100B is turned off. In this case, at the time t1, the detection state of the cap 20 by the sensor unit 112B changes from “detection” to “non-detection”. Accordingly, the control unit 116B can detect that the cap 20 is removed from the main body portion 10 at the time t1.

Then, when it is detected that the cap 20 is removed from the main body portion 10, the control unit 116B turns on the power supply of the inhalation device 100B. That is, the control unit 116B activates the inhalation device 100B in response to the removal of the cap 20 from the main body portion 10. Accordingly, the user can activate the inhalation device 100B simply by removing the cap 20 mounted to the main body portion 10, without performing an operation or the like on the operation button 13, and the convenience of the inhalation device 100B is improved. Further, in the inhalation device 100B, by removing the cap 20 from the main body portion 10 in this manner, attachment and detachment of the mouthpiece 124B with respect to the main body portion 10 can be performed.

Then, it is assumed that the user removes the mouthpiece 124B from the main body portion 10, at a time t2 after the time t1. In this case, at the time t2, the detection state of the mouthpiece 124B by the sensor unit 112B changes from “detection” to “non-detection”. Accordingly, the control unit 116B can detect that the mouthpiece 124B is removed from the main body portion 10 at the time t2. Further, in the inhalation device 100B, by removing the mouthpiece 124B from the main body portion 10, the stick-type base material 150 can be inserted into the internal space 141 from the opening 142 and attached to the inhalation device 100B.

Then, it is assumed that the user attaches the stick-type base material 150 to the inhalation device 100B at a time t3 after the time t2. In this case, at the time t3, the detection state of the stick-type base material 150 by the sensor unit 112B changes from “non-detection” to “detection”. Accordingly, the control unit 116B can detect that the stick-type base material 150 is attached at the time t3.

Then, it is assumed that the user attaches the mouthpiece 124B to the main body portion 10, at a time t4 after the time t3. In this case, at the time t4, the detection state of the mouthpiece 124B by the sensor unit 112B changes from “non-detection” to “detection”. Accordingly, the control unit 116B can detect that the mouthpiece 124B is attached to the main body portion 10 at the time t4.

Then, it is assumed that the user starts to press down the operation button 13 at a time t5 after the time t4. It is assumed that a state where the user presses down the operation button 13 continues to a time t7 after the time t5. Here, the time t7 is a time later than a time t6 when Tx [s] elapses from the time t5. In this case, the detection state of the operation on the operation button 13 from the time t5 to the time t7 is “detection”. Accordingly, the control unit 116B can detect the press-down of the operation button 13 from the time t5 to the time t7.

The control unit 116B determines that the heating start operation is performed at a time point when the operation button 13 is continuously pressed down for Tx [s]. In the example illustrated in FIG. 4, the control unit 116B determines that the heating start operation is performed at the time t6.

As in the example illustrated in FIG. 4, when it is determined that the heating start operation is performed when the detection states of the mouthpiece 124B and the stick-type base material 150 are “detection”, the control unit 116B starts the heating control on the heating unit 121B in response to the heating start operation. That is, in the example illustrated in FIG. 4, the control unit 116B starts the heating control on the heating unit 121B (here, the heating control based on the heating profile) from the time t6 at which it is determined that the heating start operation is performed. Accordingly, the inhalation device 100B can generate the aerosol after the time t6 and deliver the generated aerosol to the user.

As described above, when the stick-type base material 150 and the mouthpiece 124B are mounted on the main body portion 10, the control unit 116B can cause the heating unit 121B to generate the aerosol in response to reception of the heating start operation (that is, input of the heating start instruction). Accordingly, the aerosol can be generated for the user who grapes the correct use method of the inhalation device 100B such as mounting the stick-type base material 150 and the mouthpiece 124B to the main body portion 10 and inputting the heating start instruction.

### (2) Second Example of Specific Operations of Inhalation Device 100B

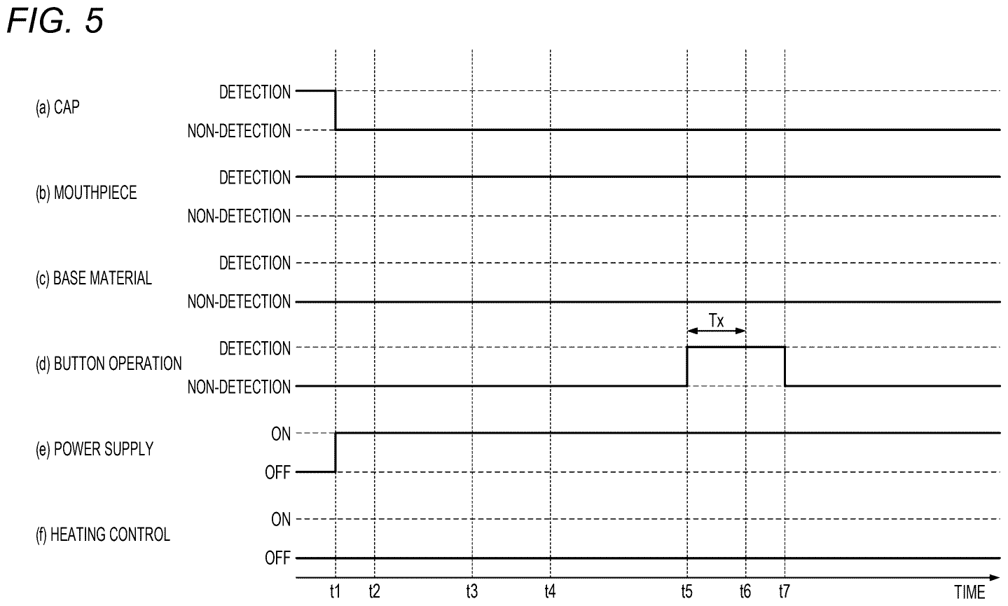

FIG. 5 is a diagram illustrating a second example of the specific operations of the inhalation device 100B. The second example is an example of a case where the control unit 116B does not perform the heating control on the heating unit 121B corresponding to the heating start operation even if the heating start operation is performed (that is, the heating start instruction is received). Here, portions different from the description of FIG. 4 will be mainly described, and description of portions common to the description of FIG. 4 will be omitted or simplified as appropriate.

In the example illustrated in FIG. 5, the user presses down the operation button 13 from the time t5 without going through a procedure of removing the mouthpiece 124B at the time t2 illustrated in FIG. 4, attaching the stick-type base material 150 at the time t3, and attaching the mouthpiece 124B at the time t4.

In the example illustrated in FIG. 5, the detection state of the stick-type base material 150 at the time t6 at which it is determined that the heating start operation is performed is “non-detection”. As in the example illustrated in FIG. 5, even if the heating start operation is performed when the detection state of the stick-type base material 150 is “non-detection”, the control unit 116B does not perform the heating control on the heating unit 121B corresponding to the heating start operation. That is, in the example illustrated in FIG. 5, an off state of the heating control on the heating unit 121B is also maintained after the time t6.

In order to reduce power consumption of the inhalation device 100B, for example, when the heating control on the heating unit 121B is not started within a predetermined time after the power supply of the inhalation device 100B is turned on, the control unit 116B may turn off the power supply of the inhalation device 100B at that time.

As described above, in a case where at least the stick-type base material 150 is not mounted on the main body portion 10, even if the heating start operation is performed (that is, the heating start instruction is received), the control unit 116B can prevent the generation of aerosol that uses the heating unit 121B. Accordingly, it is possible to prevent the generation of aerosol in response to an input from the user, such as a child, who does not grasp the correct use method of the inhalation device 100B such as mounting the stick-type base material 150 and the mouthpiece 124B to the main body portion 10. Accordingly, the occurrence of inconvenience caused by the misuse by such a user can be prevented.

### (3) Third Example of Specific Operations of Inhalation Device 100B

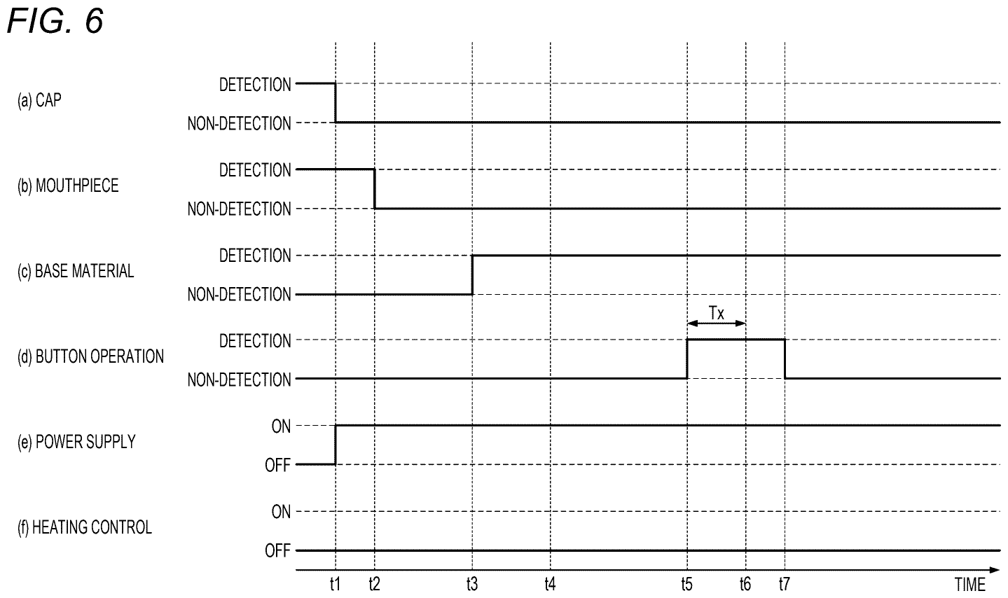

FIG. 6 is a diagram illustrating a third example of the specific operations of the inhalation device 100B. The third example is another example of a case where the control unit 116B does not perform the heating control on the heating unit 121B corresponding to the heating start operation even if the heating start operation is performed (that is, the heating start instruction is received). Here, portions different from the description of FIG. 4 will be mainly described, and description of portions common to the description of FIG. 4 will be omitted or simplified as appropriate.

In the example illustrated in FIG. 6, the user removes the mouthpiece 124B at the time t2 illustrated in FIG. 4, and attaches the stick-type base material 150 at the time t3, but presses down the operation button 13 from the time t5 without performing the attachment of the mouthpiece 124B at the time t4.

In the example illustrated in FIG. 6, the detection state of the mouthpiece 124B at the time t6 at which it is determined that the heating start operation is performed is “non-detection”. As in the example illustrated in FIG. 6, even if the heating start operation is performed when the detection state of the mouthpiece 124B is “non-detection”, the control unit 116B does not perform the heating control on the heating unit 121B corresponding to the heating start operation. That is, in the example illustrated in FIG. 6, an off state of the heating control on the heating unit 121B is also maintained after the time t6.

As described above, at least in a case where the mouthpiece 124B is not mounted on the main body portion 10, even if the heating start operation is performed (that is, the heating start instruction is received), the control unit 116B can prevent the generation of aerosol that uses the heating unit 121B. Accordingly, it is possible to prevent the generation of aerosol in response to an input from the user, such as a child, who does not grasp the correct use method of the inhalation device 100B such as mounting the stick-type base material 150 and the mouthpiece 124B to the main body portion 10. Accordingly, the occurrence of inconvenience caused by the misuse by such a user can be prevented.

As described above, before the aerosol can be inhaled using the inhalation device 100B, the user needs to follow a procedure that includes a plurality of steps, such as (1) attachment of the stick-type base material 150, (2) attachment of the mouthpiece 124B, and (3) the heating start operation. In other words, with the inhalation device 100B, the user is forced to overcome many hurdles before starting to smoke. Therefore, a robust CR function capable of further preventing the misuse by the user, such as a child who does not grasp the correct use method of the inhalation device 100B can be realized.

### (4) Fourth Example of Specific Operations of Inhalation Device 100B

When it is necessary to go through a procedure including a plurality of steps before the aerosol can be inhaled, it is conceivable that some users may want to know a current progress of the plurality of steps in order to get an idea of how soon they will be able to inhale the aerosol.

Therefore, the control unit 116B may cause the notification unit 113B to perform the first notification when the stick-type base material 150 is mounted to the main body portion 10, cause the notification unit 113B to perform the second notification when the mouthpiece 124B is mounted to the main body portion 10, and cause the notification unit 113B to perform the third notification when the heating start operation is received (that is, the heating start instruction is received). Accordingly, since the notifications can be performed in conjunction with the mounting of the stick-type base material 150 and the mouthpiece 124B to the main body portion 10 and the heating start operation, it is possible for the user to grasp a progress of a procedure up when the aerosol can be inhaled, and the convenience of inhalation device 100B can be improved.

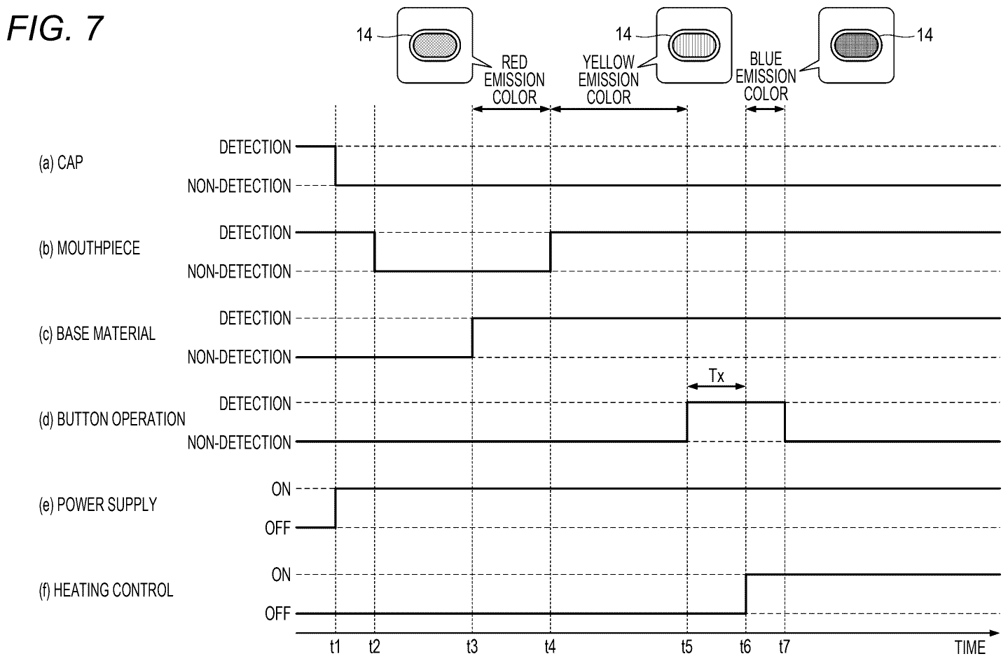

FIG. 7 is a diagram illustrating a fourth example of the specific operation of the inhalation device 100B. In the fourth example, the first notification, the second notification, and the third notification are performed by the light emitting unit 14 provided in the notification unit 113B. Here, portions different from the description of FIG. 4 will be mainly described, and description of portions common to the description of FIG. 4 will be omitted or simplified as appropriate.

In the example illustrated in FIG. 7, when it is detected that the stick-type base material 150 is attached to the main body portion 10, the control unit 116B causes the light emitting unit 14 to emit red light (refer to from the time t3 to the time t4), as the first notification.

Thereafter, when it is detected that the mouthpiece 124B is attached to the main body portion 10, the control unit 116B causes the light emitting unit 14 to emit yellow light (refer to from the time t4 to the time t5), as the second notification.

Thereafter, when the heating start operation is performed and the heating control on the heating unit 121B is started, the control unit 116B causes the light emitting unit 14 to emit blue light (refer to from the time t6 to the time t7), as the third notification.

The control unit 116B may further perform a fourth notification different from the first notification, the second notification, and the third notification when the power supply of the inhalation device 100B is turned on. Accordingly, it is possible to notify the user that the power supply of the inhalation device 100B is turned on. As an example, the control unit 116B may cause the light emitting unit 14 to emit white light, as the fourth notification.

As described above, the control unit 116B can cause the light emitting unit 14 to perform the first notification when the stick-type base material 150 is mounted to the main body portion 10, cause the light emitting unit 14 to perform the second notification when the mouthpiece 124B is mounted to the main body portion 10, and cause the light emitting unit 14 to perform the third notification when the heating start operation is received (that is, the heating start instruction is received). Accordingly, since the notifications can be performed in conjunction with the mounting of the stick-type base material 150 and the mouthpiece 124B to the main body portion 10 and the heating start instruction, it is possible for the user to grasp a progress of the procedure up when the aerosol can be inhaled, and the convenience of inhalation device 100B can be improved.

Further, by making the first notification, the second notification, and the third notification different from one another in the emission color of the light emitting unit 14, the first notification, the second notification, and the third notification can be made intuitive and easy-to-understand for the user to understand.

Here, the first notification, the second notification, and the third notification are different from one another in the emission color of the light emitting unit 14, but the present disclosure is not limited thereto. Hereinafter, examples of a case where the first notification, the second notification, and the third notification are different from one another except for the light emission color of the light emitting unit 14 will be described.

### (5-1) Another Example of Light Emitting Unit 14

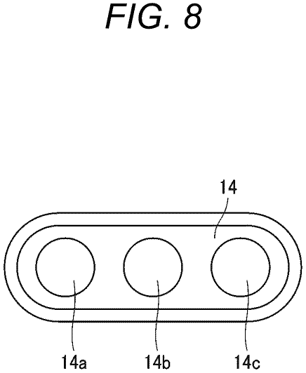

FIG. 8 is a diagram illustrating another example of the light emitting unit 14. In the example illustrated in FIG. 8, the light emitting unit 14 includes a first light emitting element 14a, a second light emitting element 14b, and a third light emitting element 14c. For example, LEDs may be adopted as the first light emitting element 14a, the second light emitting element 14b, and the third light emitting element 14c. Emission colors of the first light emitting element 14a, the second light emitting element 14b, and the third light emitting element 14c may be the same or different.

### (5-2) Fifth Example of Specific Operations of Inhalation Device 100

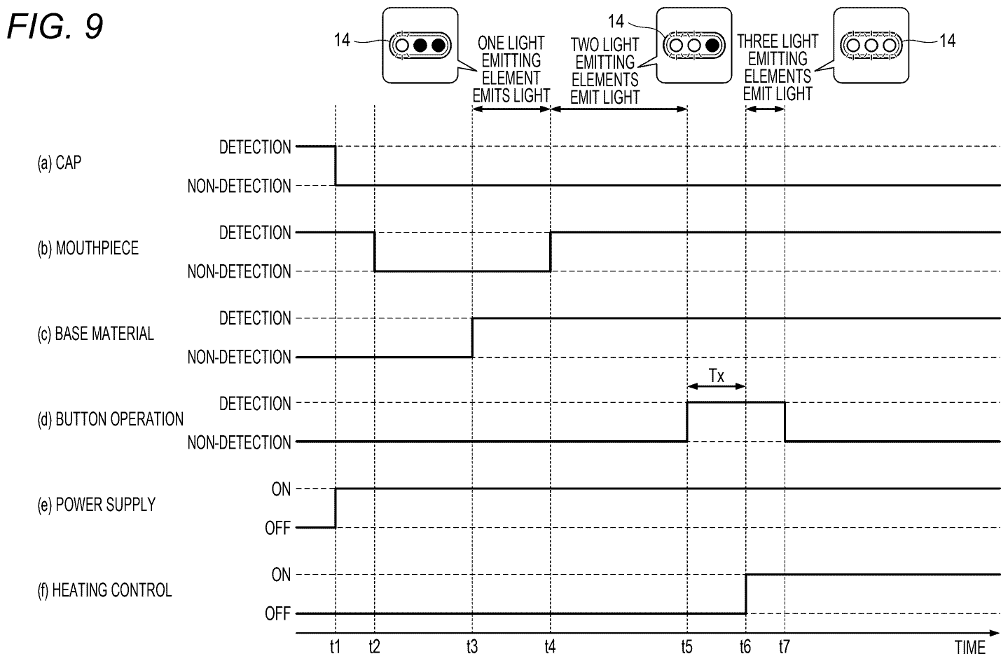

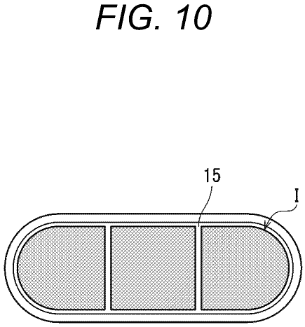

FIG. 9 is a diagram illustrating a fifth example of the specific operations of the inhalation device 100B. Here, portions different from the description of FIG. 7 will be mainly described, and description of portions common to the description of FIG. 7 will be omitted or simplified as appropriate.

In the example illustrated in FIG. 9, the first notification, the second notification, and the third notification are different from one another in the number of light emitting elements that emit light among the plurality of light emitting elements in the light emitting unit 14.

More specifically, in the example illustrated in FIG. 9, when it is detected that the stick-type base material 150 is attached to the main body portion 10, the control unit 116B causes one light emitting element (for example, the first light emitting element 14a) among the light emitting elements in the light emitting unit 14 to emit light (refer to from the time t3 to the time t4), as the first notification.

Thereafter, when it is detected that the mouthpiece 124B is attached to the main body portion 10, the control unit 116B causes two light emitting elements (for example, the first light emitting element 14a and the second light emitting element 14b) among the light emitting elements in the light emitting unit 14 to emit light (refer to from the time t4 to the time t5), as the second notification.

Thereafter, when the heating start operation is performed and the heating control on the heating unit 121B is started, the control unit 116B causes three light emitting elements among the light emitting elements in the light emitting unit 14 to emit light (refer to from the time t6 to the time t7), as the third notification.

As described above, when the first notification, the second notification, and the third notification are different from one another in the number of light emitting elements that emit light among the plurality of light emitting elements in the light emitting unit 14, the first notification, the second notification, and the third notification can also be made intuitive and easy-to-understand for the user.

Here, the first notification, the second notification, and the third notification are different from one another in the number of light emitting elements that emit light among the plurality of light emitting elements in the light emitting unit 14, but the present disclosure is not limited there to. For example, the first notification, the second notification, and the third notification may be different from one another in the light emitting element that emits light among the plurality of light emitting elements in the light emitting unit 14.

More specifically, for example, when it is detected that the stick-type base material 150 is attached to the main body portion 10, the control unit 116B may cause the first light emitting element 14a among the light emitting elements in the light emitting unit 14 to emit light, as the first notification.

Thereafter, when it is detected that the mouthpiece 124B is attached to the main body portion 10, the control unit 116B may cause the second light emitting element 14b among the light emitting elements in the light emitting unit 14 to emit light, as the second notification.

Thereafter, when the heating start operation is performed and the heating control on the heating unit 121B is started, the control unit 116B may cause the third light emitting element 14c among the light emitting elements in the light emitting unit 14 to emit light, as the third notification.

In this way, when the first notification, the second notification, and the third notification are different from one another in the light emitting element that emits light among the plurality of light emitting elements in the light emitting unit 14, the first notification, the second notification, and the third notification can also be made intuitive and easy-to-understand for the user.

### (6-1) Example of Display Unit 15

When the notification unit 113B includes a display unit that displays an image, the first notification, the second notification, and the third notification may be different from one another in a display mode of the display unit. Hereinafter, an example will be described in which the first notification, the second notification, and the third notification are different from one another in the display mode of the display unit.

FIG. 10 is a diagram illustrating an example of the display unit 15. The display unit 15 is an example of a display unit that displays an image, and is provided at a position in the inhalation device 100 that is visible to the user (for example, always visible). As the display unit 15, for example, a liquid crystal display or an organic electro-luminescence (EL) display may be adopted. The display unit 15 displays an image of an indicator I that can be displayed in three stages, for example, one-stage display, two-stage display, and three-stage display.

### (6-2) Sixth Example of Specific Operations of Inhalation Device 100B

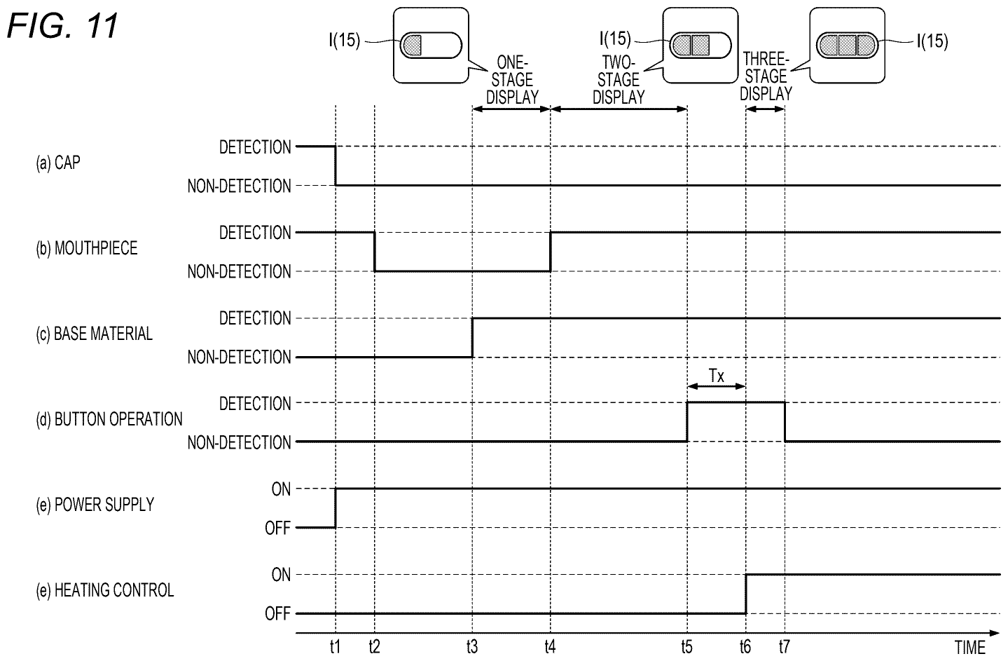

FIG. 11 is a diagram illustrating a sixth example of the specific operations of the inhalation device 100B. Here, portions different from the description of FIG. 7 will be mainly described, and description of portions common to the description of FIG. 7 will be omitted or simplified as appropriate.

In the example illustrated in FIG. 11, when it is detected that the stick-type base material 150 is attached to the main body portion 10, the control unit 116B displays the indicator I in the one-stage display (refer to from the time t3 to the time t4), as the first notification.

Thereafter, when it is detected that the mouthpiece 124B is attached to the main body portion 10, the control unit 116B displays the indicator I in the two-stage display (refer to from the time t4 to the time t5), as the second notification.

Thereafter, when the heating start operation is performed and the heating control on the heating unit 121B is started, the control unit 116B displays the indicator I in the three-stage display (refer to from the time t6 to the time t7), as the third notification.

As described above, when the first notification, the second notification, and the third notification are different from one another in the display mode of the display unit 15, the first notification, the second notification, and the third notification can also be made intuitive and easy-to-understand for the user.

When the notification unit 113B includes a vibration device (so-called vibrator) that vibrates, the first notification, the second notification, and the third notification may be different from one another in a vibration mode of the vibration device. In this case, for example, the control unit 116B may change the number of times of vibration or a vibration pattern of the vibration device in conjunction with mounting of the stick-type base material 150 and the mouthpiece 124B to the main body portion 10 and the heating start operation.

Further, when the notification unit 113B includes a sound output device (for example, a speaker) that outputs sound, the first notification, the second notification, and the third notification may be different from one another in the sound output from the sound output device. In this case, for example, the control unit 116B may change the sound to be output from the sound output device in conjunction with the mounting of the stick-type base material 150 and the mouthpiece 124B to the main body portion 10 and the heating start operation.

### <<4. Example of Processing Performed by Control Unit>>

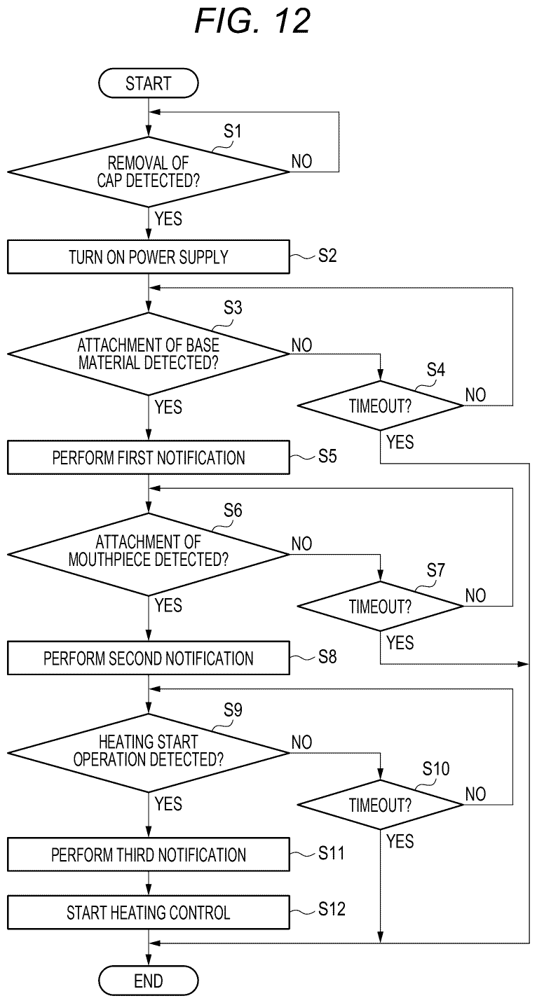

Next, an example of processing performed by the control unit 116B will be described. FIG. 12 is a flowchart illustrating the example of the processing performed by the control unit 116B.

As illustrated in FIG. 12, the control unit 116B determines whether the removal of the cap 20 from the main body portion 10 is detected (step S1). If the removal of the cap 20 is not detected (step S1: No), the control unit 116B repeats the processing of step S1 until the removal of the cap 20 is detected. Further, when it is detected that the cap 20 is removed from the main body portion 10 (step S1: Yes), the control unit 116B turns on the power supply of the inhalation device 100B (step S2).

Next, the control unit 116B determines whether attachment of the stick-type base material 150 to the main body portion 10 is detected (step S3). If the attachment of the stick-type base material 150 to the main body portion 10 is not detected (step S3: No), the control unit 116B determines, for example, whether a timeout occurs after a predetermined time (for example, 1 [min]) has elapsed since the processing of step S3 is started (step S4). If the timeout does not occur (step S4: No), the control unit 116B repeats the processing of step S3 until the timeout occurs.

When the timeout occurs (step S4: Yes), the control unit 116B ends the series of processing illustrated in FIG. 12. Accordingly, for example, after the removal of the cap 20 is detected, the heating control on the heating unit 121B may not be performed if the stick-type base material 150 is not attached within a predetermined time. Accordingly, it is possible to prevent the occurrence of inconvenience caused by misuse of the user such as a child who does not grasp the correct use method of the inhalation device 100B.

Further, when it is detected that the stick-type base material 150 is attached to the main body portion 10 (step S3: Yes), the control unit 116B causes the notification unit 113B (for example, the light emitting unit 14) to perform the first notification (step S5).

Next, the control unit 116B determines whether attachment of the mouthpiece 124B to the main body portion 10 is detected (step S6). If the attachment of the mouthpiece 124B to the main body portion 10 is not detected (step S6: No), the control unit 116B determines, for example, whether a timeout occurs after a predetermined time (for example, 1 [min]) has elapsed since the processing of step S6 is started (step S7). If the timeout does not occur (step S7: No), the control unit 116B repeats the processing of step S6 until the timeout occurs.

When the timeout occurs (step S7: Yes), the control unit 116B ends the series of processing illustrated in FIG. 12. Accordingly, for example, after the attachment of the stick-type base material 150 is detected, the heating control on the heating unit 121B may not be performed if the mouthpiece 124B is not attached within a predetermined time. Accordingly, it is possible to prevent the occurrence of inconvenience caused by misuse of the user such as a child who does not grasp the correct use method of the inhalation device 100B.

When it is detected that the mouthpiece 124B is attached to the main body portion 10 (step S6: Yes), the control unit 116B causes the notification unit 113B (for example, the light emitting unit 14) to perform the second notification (step S8).

Next, the control unit 116B determines whether the heating start operation is performed (step S9). If the heating start operation is not performed (step S9: No), the control unit 116B determines, for example, whether a timeout occurs after a predetermined time (for example, 1 [min]) has elapsed since the processing of step S9 is started (step S10). If the timeout does not occur (step S10: No), the control unit 116B repeats the processing of step S9 until the timeout occurs.

When the timeout occurs (step S10: Yes), the control unit 116B ends the series of processing illustrated in FIG. 12. Accordingly, for example, after the attachment of the mouthpiece 124B is detected, the heating control on the heating unit 121B may not be performed if the heating start operation is not performed within a predetermined time. Accordingly, it is possible to prevent the occurrence of inconvenience caused by misuse of the user such as a child who does not grasp the correct use method of the inhalation device 100B.

When it is determined that the heating start operation is performed (step S9: Yes), the control unit 116B causes the notification unit 113B (for example, the light emitting unit 14) to perform the third notification (step S11), starts the heating control on the heating unit 121B (step S12), and ends the series of processing illustrated in FIG. 12.

As described above, according to the present embodiment, it is possible to prevent the inhalation device 100 from operating in response to an input from the user, such as a child, who does not grasp the correct use method of the inhalation device 100, such as mounting the base material including the aerosol source such as the cartridge 120, the flavor imparting cartridge 130, or the stick-type base material 150, and the mouthpiece 124 to the main body portion 10. Accordingly, the occurrence of inconvenience caused by misuse by such a user can be prevented, the performance of the CR function in the inhalation device 100 is improved, and the marketability of the inhalation device 100 is improved.

In the embodiment described above, the power supply of the inhalation device 100 is turned on in response to the removal of the cap 20 from the main body portion 10 (that is, the inhalation device 100 is activated), but the present disclosure is not limited thereto.

For example, when the base material including the aerosol source such as the cartridge 120, the flavor imparting cartridge 130, or the stick-type base material 150, and the mouthpiece 124 are mounted on the main body portion 10, the control unit 116 may activate the inhalation device 100 in response to reception of an input of an activation instruction from the user. Then, after the activation of the inhalation device 100, the control unit 116 may cause the heating unit 121 to generate the aerosol in response to reception of the heating start instruction (for example, the heating start operation).

Here, the activation instruction can be a predetermined operation instructing activation to the inhalation device 100 (hereinafter also referred to as an “activation operation”). Similarly to the heating start operation, the activation operation can be an operation using the operation button 13, and can be, for example, long-pressing the operation button 13 when the power supply of the inhalation device 100 is turned off. The activation operation may be a plurality of times of press-down of the operation button 13 when the power supply of the inhalation device 100 is turned off. Accordingly, it is possible to prevent the activation operation from being unintentionally performed by the user such as a child who does not grasp the correct use method of the inhalation device 100, as compared with a case where the activation operation is a simple “press-down of the operation button 13.

Further, in the inhalation device 100B illustrated in FIG. 1B, the stick-type base material 150 is held by accommodating a part of the stick-type base material 150 in the accommodating portion 140, but the present disclosure is not limited thereto.

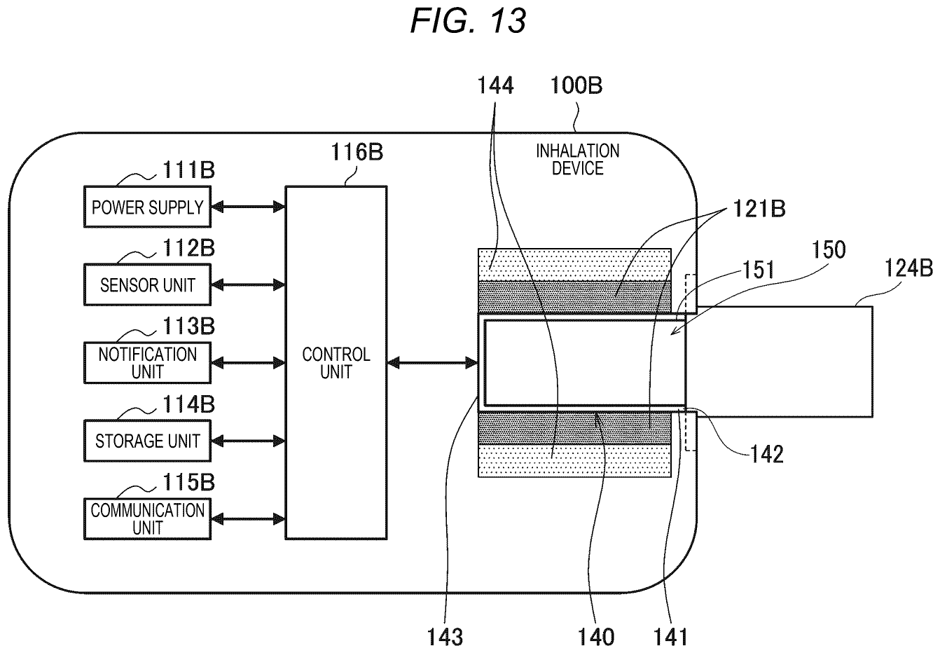

FIG. 13 is a diagram illustrating a modification of the inhalation device 100B illustrated in FIG. 1B. In the inhalation device 100B, since the aerosol is delivered to the user via the mouthpiece 124B, the stick-type base material 150 does not include an inhalation port portion that the user holds in his/her mouth. Therefore, as illustrated in FIG. 13, a part of the stick-type base material 150 does not have to protrude outside the accommodating portion 140, and the entire stick-type base material 150 may be accommodated in the accommodating portion 140. In other words, the main body portion 10 of the inhalation device 100B may include the accommodating portion 140 that accommodates the entire stick-type base material 150 that is mounted. Accordingly, the stick-type base material 150 can be simplified and reduced in size while preventing a decrease in the convenience of the inhalation device 100B, and the number of components and a necessary material constituting the stick-type base material 150 can be reduced.

Further, the inhalation device 100 has not only the function of generating the aerosol by the heating unit 121 described above, but also other functions such as communication with an external device via a communication unit 115 (115A, 115B). It is also anticipated that among the various functions of the inhalation device 100, there are some that are likely to cause inconvenience caused by the misuse by the child, or the like, and others that are relatively unlikely to cause inconvenience.

Therefore, regarding the various functions of the inhalation device 100, the control unit 116 may vary severity of the hurdles for activating the functions. Accordingly, the inhalation device 100 with higher convenience can be provided.

Specifically, the control unit 116 may be configured to allow the inhalation device 100 to perform another operation different from the generation of the aerosol using the heating unit 121, when at least one of the base material including the aerosol source such as the cartridge 120, the flavor imparting cartridge 130, or the stick-type base material 150, and the mouthpiece 124 is not mounted on the main body portion 10. Here, the other operation can be, for example, communication with an external device via the communication unit 115. Examples of the external device include a smartphone of the user and a server managed by a manufacturer of the inhalation device 100.

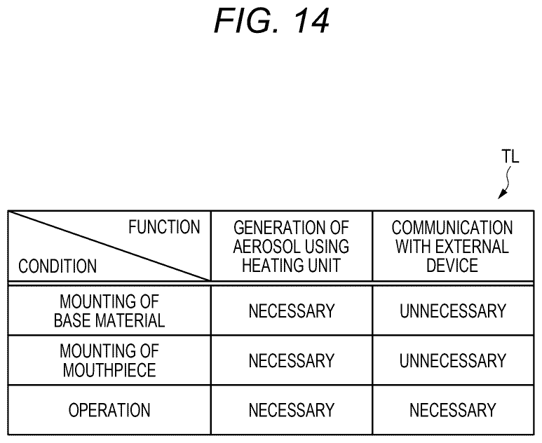

FIG. 14 is a diagram illustrating an example of conditions for generating the aerosol by the heating unit 121 and conditions for communicating with the external device via the communication unit 115. For example, as illustrated in a table TL of FIG. 14, the control unit 116 requires all of the mounting of the base material including the aerosol source, the mounting of the mouthpiece 124, and the operation using the operation button 13 (for example, the heating start operation described above) in order to generate the aerosol by the heating unit 121. Accordingly, the generation of the aerosol by the heating unit 121 can be prevented more firmly with respect to the user such as a child who does not grasp the correct use method of the inhalation device 100.

Meanwhile, in order to perform communication with the external device via the communication unit 115, the control unit 116 may require the operation using the operation button 13, but may not require the mounting of the base material including the aerosol source or the mounting of the mouthpiece 124. That is, even if at least one of the base material including the aerosol source and the mouthpiece 124 is not mounted on the inhalation device 100, when there is a predetermined operation on the operation button 13 from the user, the control unit 116 may communicate with the external device via the communication unit 115. Accordingly, in this case, the user can cause the inhalation device 100 and the external device to communicate with each other without mounting the base material including the aerosol source or the mouthpiece 124 to the inhalation device 100.

Then, the communication between the inhalation device 100 and the external device can realize, for example, update of a control program of the inhalation device 100 (for example, the heating profile, a lighting control program of the LED of the light emitting unit 14, a charge or discharge control program of the power supply 111, and the like), various authentications, and transmission and reception of various data related to smoking using the inhalation device 100. Accordingly, the inhalation device 100 with higher convenience can be provided.

As an example, in a case where the operation button 13 is long-pressed after the cap 20 is removed from the main body portion 10 or the like and the power supply of the inhalation device 100 is turned on, the control unit 116 may cause the heating unit 121 to generate the aerosol if the base material and the mouthpiece 124 are mounted, and may allow the communication with the external device if at least one of the base material and the mouthpiece 124 is not mounted.

Although the embodiments of the present invention have been described above with reference to the accompanying drawings, it is needless to say that the present invention is not limited to such an embodiment. It is apparent to a person skilled in the art that various changes and modifications may be conceived within the scope described in the claims, and it is understood that the changes and the modifications naturally fall within the technical scope of the present invention. In addition, the constituent components described in the above embodiments may be optionally combined without departing from the spirit of the invention.

A control method of the inhalation device 100 described in the above embodiment can be achieved by executing a program prepared in advance on a computer (a processor). The program is stored in a computer-readable storage medium and is executed by being read from the storage medium. Further, the program may be provided in a form of being stored in a non-transitory storage medium such as a flash memory, and may be provided via a network such as the Internet. Although the computer that executes the program can be, for example, a component provided in the inhalation device 100 (for example, the CPU of the inhalation device 100), but is not limited thereto, and may be a component provided in another device (for example, a smartphone or a server) capable of communicating with the inhalation device 100.

In the present description or the like, at least the following matters are described. In parentheses, corresponding components and the like in the above-described embodiments are illustrated as an example, and the present invention is not limited thereto.

(1) An inhalation device (inhalation device 100, 100A, 100B) that generates an aerosol from a base material (cartridge 120, flavor imparting cartridge 130, stick-type base material 150) including an aerosol source and delivers the generated aerosol to a user via a mouthpiece (mouthpiece 124, 124A, 124B), the inhalation device including:
a main body portion (main body portion 10) configured to allow the base material and the mouthpiece to be mounted thereon;
an input unit (operation button 13, sensor unit 112, 112A, 112B) configured to receive an input from the user; and
a control unit (control unit 116, 116A, 116B) configured to control an operation of the inhalation device, in which
when the base material and the mouthpiece are mounted on the main body portion, the control unit causes the inhalation device to perform an operation corresponding to the input received by the input unit.

According to (1), it is possible to prevent the inhalation device from operating in response to an input from a user such as a child who does not grasp a correct use method of the inhalation device such as mounting the base material including the aerosol source and the mouthpiece to the main body portion. Accordingly, it is possible to prevent an occurrence of inconvenience caused by misuse by the user who does not grasp the correct use method of the inhalation device.

(2) The inhalation device according to (1), in which
the main body portion further includes a heating unit (heating unit 121, 121A, 121B) configured to heat the base material mounted on the main body portion to generate the aerosol, and
when the base material and the mouthpiece are mounted on the main body portion, the control unit causes the heating unit to generate the aerosol in response to reception of a heating start instruction by the input unit.

According to (2), for the user who grapes the correct use method of the inhalation device such as mounting the base material and the mouthpiece to the main body portion and inputting the heating start instruction, the aerosol can be generated and a decrease in convenience of the inhalation device can be prevented.

(3) The inhalation device according (2), in which
the main body portion is configured to further allow a cap (cap 20) for covering the mouthpiece mounted on the main body portion to be mounted thereon.

According to (3), by mounting the cap to the main body portion, the mouthpiece mounted to the main body portion can be covered with the cap and the mouthpiece can be kept hygienically.

(4) The inhalation device according to (3), in which
the control unit activates the inhalation device in response to removal of the cap mounted on the main body portion, and
when the base material and the mouthpiece are mounted to the main body portion after the inhalation device is activated, the control unit causes the heating unit to generate the aerosol in response to the reception of the heating start instruction.

According to (4), the user can activate the inhalation device simply by removing the cap mounted on the main body portion, and the convenience of the inhalation device is improved.

(5) The inhalation device according to (2), in which
when the base material and the mouthpiece are mounted on the main body portion, the control unit activates the inhalation device in response to reception of an activation instruction by the input unit, and
after the activation of the inhalation device, the control unit causes the heating unit to generate the aerosol in response to the reception of the heating start instruction.

According to (5), for the user who grapes the correct use method of the inhalation device such as inputting the heating start instruction after mounting the base material and the mouthpiece to the main body portion and inputting the activation instruction, the aerosol can be generated and the decrease in convenience of the inhalation device can be prevented.

(6) The inhalation device according to (5), in which
the input unit includes an operation unit (operation button 13) configured to be pressed down by the user, and
each of the activation instruction and the heating start instruction is a long press or a plurality of times of press-down of the operation unit.

According to (6), since the activation instruction and the heating start instruction are a long press or a plurality of times of press-down of the operation unit, the activation instruction and the heating start instruction can be prevented from being unintentionally performed by the user who does not grasp the correct use method of the inhalation device.

(7) The inhalation device according to any one of (2) to (6), further including:
a notification unit (notification unit 113, 113A, and 113B) configured to notify the user of a predetermined notification, in which
the control unit causes the notification unit to perform a first notification when the base material is mounted to the main body portion, causes the notification unit to perform a second notification when the mouthpiece is mounted to the main body portion, and causes the notification unit to perform a third notification when the heating start instruction is received.

According to (7), since the notification can be performed in conjunction with the mounting of the base material and the mouthpiece to the main body portion and the heating start instruction, it is possible for the user to grasp a progress of a procedure up when the aerosol can be inhaled, and the convenience of inhalation device can be improved.

(8) The inhalation device according to (7), in which
the notification unit includes a light emitting unit (light emitting unit 14) configured to emit light, and
the first notification, the second notification, and the third notification are different from one another in a light emitting mode of the light emitting unit.

According to (8), the first notification, the second notification, and the third notification can be made intuitive and easy-to-understand for the user.

(9) The inhalation device according to (8), in which
the light emitting unit is configured to emit light in a plurality of emission colors, and
the first notification, the second notification, and the third notification are different from one another in the emission colors of the light emitting unit.

According to (9), the first notification, the second notification, and the third notification can be made intuitive and easy-to-understand for the user.

(10) The inhalation device according to (8), in which
the light emitting unit includes a plurality of light emitting elements (first light emitting element 14a, second light emitting element 14b, and third light emitting element 14c), and
the first notification, the second notification, and the third notification are different from one another in the light emitting element that emits light or the number of light emitting elements that emit light among the plurality of light emitting elements.

According to (10), the first notification, the second notification, and the third notification can be made intuitive and easy-to-understand for the user.

(11) The inhalation device according to (7), in which
the notification unit includes a display unit (display unit 15) configured to display an image, and
the first notification, the second notification, and the third notification are different from one another in a display mode of the display unit.

According to (11), the first notification, the second notification, and the third notification can be made intuitive and easy-to-understand for the user.

(12) The inhalation device according to any one of (2) to (11), in which
the control unit is configured to allow the inhalation device to perform another operation different from the generation of the aerosol using the heating unit when at least one of the base material and the mouthpiece is not mounted on the main body portion.

According to (12), even if at least one of the base material and the mouthpiece is not mounted on the main body portion, another operation different from the generation of the aerosol can be performed by the inhalation device, and thus the convenience of the inhalation device is improved.

(13) The inhalation device according to any one of (1) to (12), in which
the base material does not include an inhalation port portion that the user holds in his/her mouth.

According to (13), since the base material does not include the inhalation port portion, the base material can be simplified or reduced in size, and the number of components and a necessary material constituting the base material can be reduced.

(14) A control method to be performed by a computer (control unit 116, 116A, 116B) for controlling an operation of an inhalation device (inhalation device 100, 100A, 100B) that generates an aerosol from a base material (cartridge 120, flavor imparting cartridge 130, stick-type base material 150) including an aerosol source and delivers the generated aerosol to a user via a mouthpiece (mouthpiece 124, 124A, 124B), the inhalation device including:
a main body portion (main body portion 10) configured to allow the base material and the mouthpiece to be mounted thereon, and
an input unit (operation button 13, sensor unit 112, 112A, 112B) configured to receive an input from the user, the control method including:
when the base material and the mouthpiece are mounted on the main body portion, the computer causing the inhalation device to perform an operation corresponding to the input received by the input unit.

According to (14), it is possible to prevent the inhalation device from operating in response to the input from the user such as a child who does not grasp the correct use method of the inhalation device such as mounting the base material including the aerosol source and the mouthpiece to the main body portion. Accordingly, it is possible to prevent the occurrence of inconvenience caused by misuse by the user who does not grasp the correct use method of the inhalation device.

(15) A non-transitory computer-readable storage medium storing a program to be executed by a computer (control unit 116, 116A, 116B) for controlling an operation of an inhalation device (inhalation device 100, 100A, 100B) that generates an aerosol from a base material (cartridge 120, flavor imparting cartridge 130, stick-type base material 150) including an aerosol source and delivers the generated aerosol to a user via a mouthpiece (mouthpiece 124, 124A, 124B), the inhalation device including:
a main body portion (main body portion 10) configured to allow the base material and the mouthpiece to be mounted thereon, and
an input unit (operation button 13, sensor unit 112, 112A, 112B) configured to receive an input from the user,
the program causing, when the base material and the mouthpiece are mounted on the main body portion, the computer to cause the inhalation device to perform an operation corresponding to the input received by the input unit.

According to (15), it is possible to prevent the inhalation device from operating in response to the input from the user such as a child who does not grasp the correct use method of the inhalation device such as mounting the base material including the aerosol source and the mouthpiece to the main body portion. Accordingly, it is possible to prevent the occurrence of inconvenience caused by misuse by the user who does not grasp the correct use method of the inhalation device.

What is claimed is:

1. An inhalation device that generates an aerosol from a base material including an aerosol source and delivers the generated aerosol to a user via a mouthpiece, the inhalation device comprising:
a main body portion configured to allow the base material and the mouthpiece to be mounted thereon;
an input unit configured to receive an input from the user; and
a control unit configured to control an operation of the inhalation device, wherein
when the base material and the mouthpiece are mounted on the main body portion, the control unit causes the inhalation device to perform an operation corresponding to the input received by the input unit.

2. The inhalation device according to claim 1, wherein
the main body portion further includes a heating unit configured to heat the base material mounted on the main body portion to generate the aerosol, and
when the base material and the mouthpiece are mounted on the main body portion, the control unit causes the heating unit to generate the aerosol in response to reception of a heating start instruction by the input unit.

3. The inhalation device according claim 2, wherein
the main body portion is configured to further allow a cap for covering the mouthpiece mounted on the main body portion to be mounted thereon.

4. The inhalation device according to claim 3, wherein
the control unit activates the inhalation device in response to removal of the cap mounted on the main body portion, and
when the base material and the mouthpiece are mounted to the main body portion after the inhalation device is activated, the control unit causes the heating unit to generate the aerosol in response to the reception of the heating start instruction.

5. The inhalation device according to claim 2, wherein
when the base material and the mouthpiece are mounted on the main body portion, the control unit activates the inhalation device in response to reception of an activation instruction by the input unit, and
after the activation of the inhalation device, the control unit causes the heating unit to generate the aerosol in response to the reception of the heating start instruction.

6. The inhalation device according to claim 5, wherein
the input unit includes an operation unit configured to be pressed down by the user, and
each of the activation instruction and the heating start instruction is a long press or a plurality of times of press-down of the operation unit.

7. The inhalation device according to claim 2, further comprising:
a notification unit configured to notify the user of a predetermined notification, wherein
the control unit causes the notification unit to perform a first notification when the base material is mounted to the main body portion, causes the notification unit to perform a second notification when the mouthpiece is mounted to the main body portion, and causes the notification unit to perform a third notification when the heating start instruction is received.

8. The inhalation device according to claim 7, wherein
the notification unit includes a light emitting unit configured to emit light, and
the first notification, the second notification, and the third notification are different from one another in a light emitting mode of the light emitting unit.

9. The inhalation device according to claim 8, wherein
the light emitting unit is configured to emit light in a plurality of emission colors, and
the first notification, the second notification, and the third notification are different from one another in the emission colors of the light emitting unit.

10. The inhalation device according to claim 8, wherein
the light emitting unit includes a plurality of light emitting elements, and
the first notification, the second notification, and the third notification are different from one another in the light emitting element that emits light or the number of light emitting elements that emit light among the plurality of light emitting elements.

11. The inhalation device according to claim 7, wherein
the notification unit includes a display unit configured to display an image, and
the first notification, the second notification, and the third notification are different from one another in a display mode of the display unit.

12. The inhalation device according to claim 2, wherein
the control unit is configured to allow the inhalation device to perform another operation different from the generation of the aerosol using the heating unit when at least one of the base material and the mouthpiece is not mounted on the main body portion.

13. The inhalation device according to claim 1, wherein
the base material does not include an inhalation port portion that the user holds in his/her mouth.

14. A control method to be performed by a computer for controlling an operation of an inhalation device that generates an aerosol from a base material including an aerosol source and delivers the generated aerosol to a user via a mouthpiece, the inhalation device including:
a main body portion configured to allow the base material and the mouthpiece to be mounted thereon, and
an input unit configured to receive an input from the user, the control method comprising:
when the base material and the mouthpiece are mounted on the main body portion, the computer causing the inhalation device to perform an operation corresponding to the input received by the input unit.

15. A non-transitory computer-readable storage medium storing a program to be executed by a computer for controlling an operation of an inhalation device that generates an aerosol from a base material including an aerosol source and delivers the generated aerosol to a user via a mouthpiece, the inhalation device including:
a main body portion configured to allow the base material and the mouthpiece to be mounted thereon, and
an input unit configured to receive an input from the user,
the program causing, when the base material and the mouthpiece are mounted on the main body portion, the computer to cause the inhalation device to perform an operation corresponding to the input received by the input unit.
